(19) United States
(12) Patent Application Publication
(10) Pub. No.: US 2007/0233584 A1
(43) Pub. Date: Oct. 4, 2007

(54) Logistics auditing system and method

(75) Inventors: Neil Chen, Taipei (TW); Celn Chen, Taipei (TW); Hiweed Leng, Taipei (TW); Alan Lo, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/391,807

(22) Filed: Mar. 28, 2006

(51) Int. Cl. G06F 17/50

(52) U.S. Cl. 705/29

(57) ABSTRACT

A logistics auditing system and method are disclosed. The logistics auditing method is applicable to an enterprise resource planning (ERP) system stored with logistics data and a customs system stored with customs data. The method first establishes a correspondence data table listing a correspondence relation between the logistics data and the customs data, then inputs logistics data of goods ready to be audited, captures corresponding goods quantity information according to the logistics data and reads customs quantity information corresponding to the customs data in accordance with the correspondence data table, compares the material quantity with the customs quantity, and outputs alarm messages when the material quantity is determined to be different from the customs quantity. Therefore, an enterprise is allowed to monitor a customs bonded/logistics process, and the efficiency of the logistics auditing process is greatly improved.

### BACKGROUND OF THE INVENTION

1. Field of the Invention

The present invention relates to a logistics auditing system and method, and more particularly, to a logistic auditing system and method to audit if a logistics process is correct in accordance with customs data.

2. Description of Related Art

Customs regulations require enterprises to provide their operational data of production logistics processes based on manufacture trade management codes and customs bonded management codes, so as to monitor the logistics processes of the enterprises. Customs officials are allowed to select and focus on some of the products produced by an enterprise in accordance with production material lists and product lists provided by the enterprise, calculate a current theoretical stock quantity of the enterprise according to input/output data and production form data provided daily by the enterprise, and check if the theoretical stock quantity is equal to enterprise resource planning stock data the enterprise provides to customs every predetermined period. By setting an endurable difference ratio, customs officials regard the product situation as abnormal if the checking result is higher than the endurable difference ratio, subsequently spot-checking the products or asking the enterprise to explain the abnormal situation. Moreover, customs officials are allowed to track the usage of a stock of materials of the enterprise according to the input/output data and production form data provided by the enterprise. Customs officials are further allowed to examine the structure of the products and analyze the real production situation of the enterprise.

However, customs officials care about the stock of key products and ask the enterprise to provide only basic data as corresponding reference data for an auditing process. Such a scenario is too simplified to satisfy the monitoring demand of a customs logistics process required by the enterprises. In other words, if the customs officials rely on the basic data to execute the auditing process, often, an enterprise cannot find the source (during an input process or an output process) of an abnormal situation and executes a corresponding source probing process right away when the abnormal situation happens.

Moreover, a current auditing process requires auditing personnel of the enterprise to check the input/output data during every time cycle manually, and has too low of an auditing efficiency due to too complicated data. In order to prevent the abnormal situation from affecting the whole operation of the enterprise, the enterprise has to monitor daily logistics information regularly. If the enterprise provides too much data, customs officials will request the enterprise to transmit the data information every predetermined period (for example ten days). Therefore, the enterprise can not guarantee the immediateness of the monitoring of the customs logistics process every time providing the data information to the customs officials.

Therefore, how to provide a logistics auditing system and method capable of effectively and efficiently monitoring the customs logistics process of the enterprise is a critical need in the art.

### SUMMARY OF THE INVENTION

In views of the above-mentioned problems of the prior art, it is a primary objective of the present invention to provide a logistics auditing system and method for allowing an enterprise to monitor a customs bonded logistics process, improving the efficiency of a logistics auditing process.

It is another objective of the present invention to provide a logistics auditing system and method for allowing an enterprise to find and handle abnormal problems in time in the logistics auditing process, so as to ensure the correctness of the data information the enterprise provides to customs officials.

To achieve the above-mentioned and other objectives, a logistics auditing system is provided according to the present invention. The logistics auditing system is connected with an enterprise resource planning (ERP) system having a logistics management database and a customs system having a customs management database for monitoring and managing goods ready to be audited. The logistics management database is used to store a variety of logistical data including logistics types, material names, and goods quantity information. The customs management database is used to store a variety of customs data including customs types, customs material names, and customs quantity information. The logistics auditing system includes a correspondence module for establishing a correspondence data table listing a correspondence relation between the logistics data and the customs data; an input module for inputting the logistics types and the material names of the goods ready to be audited; a capture module for capturing corresponding goods quantity information from the logistics management database according the logistics types and material names input to the input module, and reading from the correspondence data table established by the correspondence module customs types and customs material names of the logistics types and material names of the goods ready to be audited, so as to capture from the customs management database the customs quantity information corresponding to the customs types and the customs material names; and a comparison module for receiving the goods quantity information and the customs quantity information and comparing the material quantity with the customs quantity, and for generating alarm messages when the material quantity is compared to be different from the customs quantity.

The present invention further discloses a logistics auditing method. The logistics auditing method includes establishing a correspondence data table listing a correspondence relation between the logistics data and customs data; inputting logistics types and material names of the goods ready to be audited; capturing from the logistics management database corresponding goods quantity information according to the logistics types and material names of the goods ready to be audited; reading customs types and customs material names corresponding to the logistics types and material names of the goods ready to be audited, and capturing from the customs management database customs quantity information corresponding to the customs types and customs material names; and receiving the goods quantity information and the customs quantity information and comparing the material quantity with the customs quantity, and outputting alarm messages when the material quantity is compared to be different from the customs quantity.

By comparing the logistics data stored in the logistics management database of the enterprise resource planning system with the customs data stored in the customs management database of the customs system, the logistics auditing system and method of the present invention can be used to monitor and manage a logistics process of an enterprise, and improve the efficiency of a logistics auditing process. Moreover, the enterprise can be informed by the alarm messages generated due to a difference between the material quantity and the customs quantity that the enterprise has to execute a source probing process. Therefore, the enterprise can urge related personnel to amend related information, and provide correct ERP data to customs officials.

### BRIEF DESCRIPTION OF DRAWINGS

The invention can be more fully understood by reading the following detailed description of the preferred embodiments, with reference made to the accompanying drawings, wherein:

FIG. 1 is a functional block diagram of an enterprise resource planning (ERP) system, a customs system, and a logistics auditing system of the preferred embodiment according to the present invention;

FIG. 2A is a logistics table listing logistics data of a logistics management database of the ERP system shown in FIG. 1;

FIG. 2B is a customs table listing customs data of a customs management database of the custom system shown in FIG. 1;

FIG. 2C is a correspondence data table listing a correspondence relation between the customs data shown in FIG. 2B and the logistics data shown in FIG. 2A; and

FIG. 3 is a flow chart of a logistics auditing method corresponding to the logistics auditing system shown in FIG. 1.

### DETAILED DESCRIPTION OF PREFERRED EMBODIMENTS

The following illustrative embodiments are provided to illustrate the disclosure of the present invention, these and other advantages and effects being readily understood by those in the art after reading the disclosure of this specification. The present invention can also be performed or applied by other differing embodiments. The details of the specification may be modified on the basis of different points and applications, and numerous modifications and variations can be devised without departing from the spirit of the present invention.

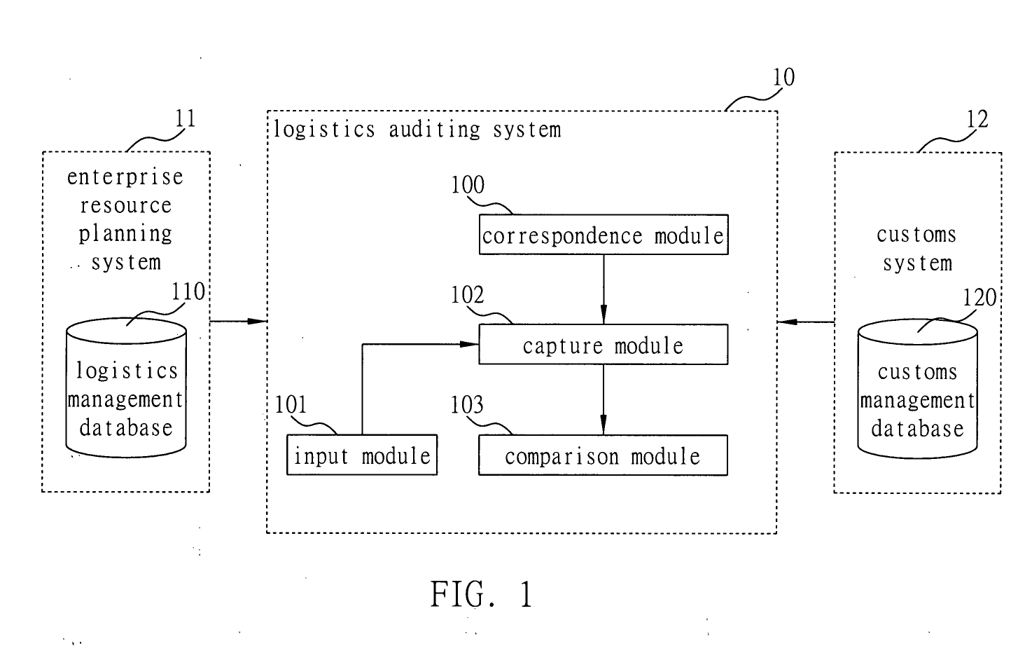

FIG. 1 is a functional block diagram of the preferred embodiment according to the present invention having an enterprise resource planning (ERP) system 11 with a logistics management database 110, a customs system 12 with a customs management database 120, and a logistics auditing system 10. The logistics auditing system 10 comprises a correspondence module 100, an input module 101, a capture module 102, and a comparison module 103. The logistics auditing system 10 is applicable to a network communications system, and is connected to the ERP system 11 and the customs system 12 for monitoring and managing goods (products or material) ready to be audited. The logistics management database 110 is used to store a variety of logistics data, such as logistics types, goods names, and goods quantity information. The customs management database 120 is used to store a variety of customs data, such as customs types, customs goods names, and customs quantity information.

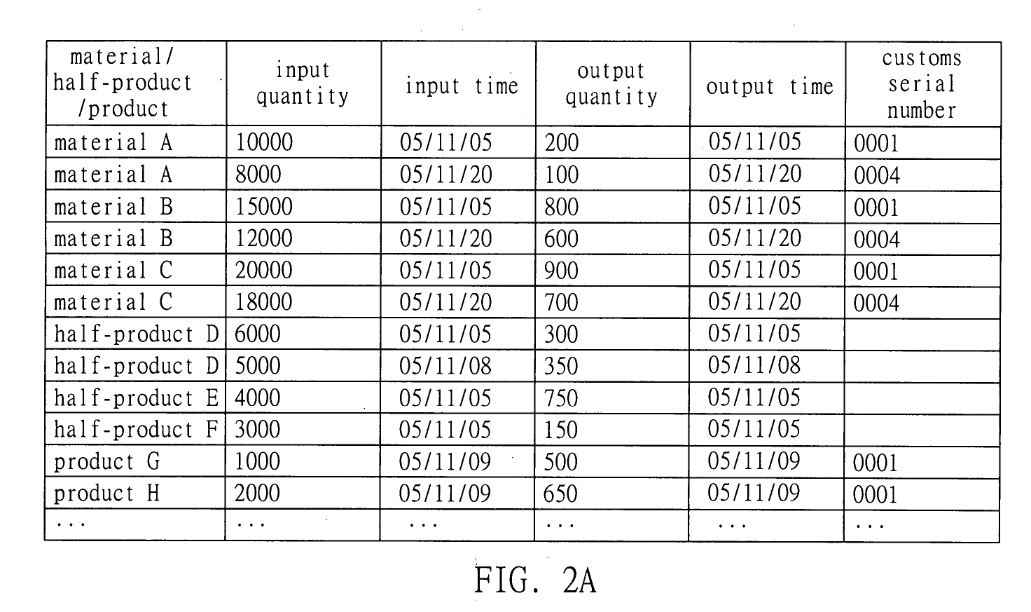

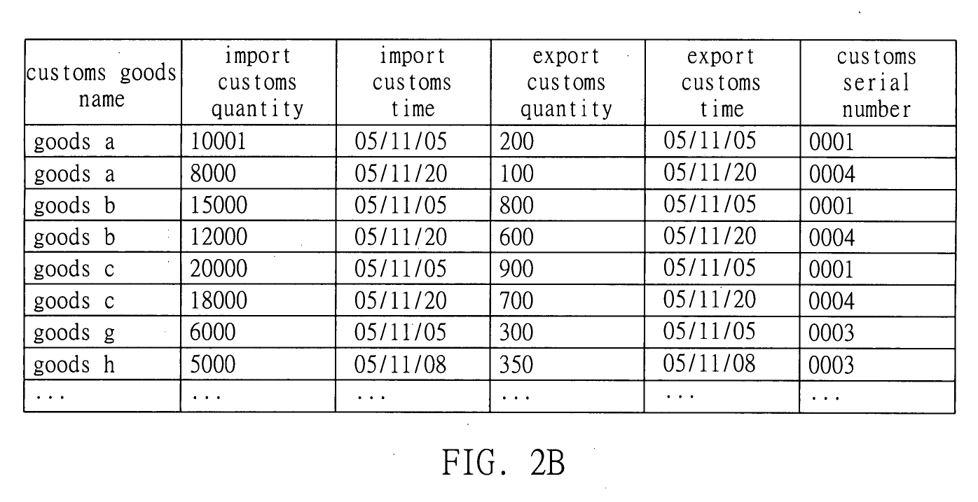

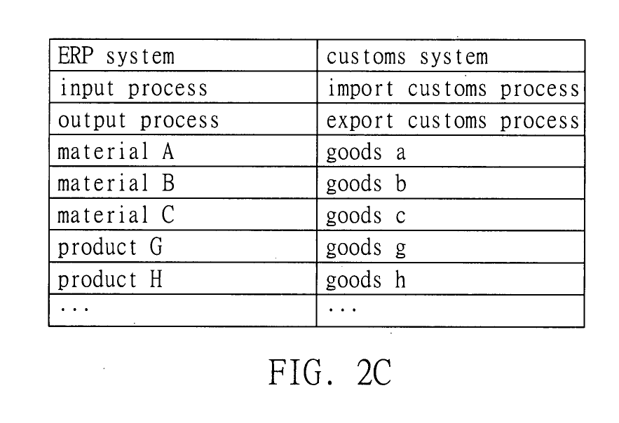

FIG. 2A is a logistics table listing logistics data of the logistics management database 110. FIG. 2B is a customs table listing customs data of the customs management database 120. FIG. 2C is a correspondence data table listing a correspondence relation between the customs data shown in FIG. 2B and the logistics data shown in FIG. 2A. In the logistics management database 110, the logistics types refer to an input process or an output process for goods, and the goods names refer to material names, half-product names or product names. In the customs management database 120, the customs types refer to an import customs process or an export customs process for goods, the customs goods names refer to customs material names or customs product names, and the customs quantity information refers to the import customs quantity or export customs quantity for the goods. Note that the logistics data and customs data are changeable in accordance with practical demands, and are not limited to the preferred embodiment.

The correspondence module 100 is used to establish a correspondence data table listing a correspondence relation for the logistics data and the customs data. The input process of the logistics management database 110 corresponds to the import customs process of the customs management database 120, while the output process of the logistics management database 110 corresponds to the export customs process of the customs management database 120. A material ‘A’ of the logistics management database 110 corresponds to goods ‘a’ of the customs management database 120. A material ‘B’ of the logistics management database 110 corresponds to goods ‘b’ of the customs management database 120. A material ‘C’ of the logistics management database 110 corresponds to goods ‘c’ of the customs management database 120. A product ‘G’ of the logistics management database 110 corresponds to goods ‘g’ of the customs management database 120. A product ‘H’ of the logistics management database 110 corresponds to a goods ‘h’ of the customs management database 120.

The input module 101 is used to input the logistics types and material names of the goods (products and material) ready to be audited. Because the logistics data of the logistics management database 110 further comprises input times and output times for the goods, the customs data of the customs management database 120 of the customs system 12 further comprises import customs times and export customs times for goods. Therefore, a user is allowed to audit a number of the goods ready to be audited during a time cycle by inputting the time cycle corresponding to the goods ready to be audited to the input module 101. The logistics data of the logistics management database 110 further comprises customs serial numbers. Accordingly, the customs data of the customs management database 120 further comprises customs serial numbers. Therefore, the user is allowed to audit the material quantity of each of a plurality of customs sheets by inputting the customs serial numbers of the goods ready to be audited to the input module 101.

The capture module 102 is used to, in accordance with the logistics types and material names of the goods ready to be audited input to the input module 101, capture the goods quantity information corresponding to the goods ready to be audited from the logistics management database 110, and read the logistics types of the goods ready to be audited and the customs types and customs material names of the material name according to the correspondence data table generated by the correspondence module 100. Therefore, the customs quantity information corresponding to the customs types and customs material names is captured from the customs management database 120.

The comparison module 103 is used to receive the goods quantity information and customs quantity information captured by the capture module 102, and compares the material quantity with the customs quantity, so as to output alarm messages if the material quantity is determined to be different from the customs quantity.

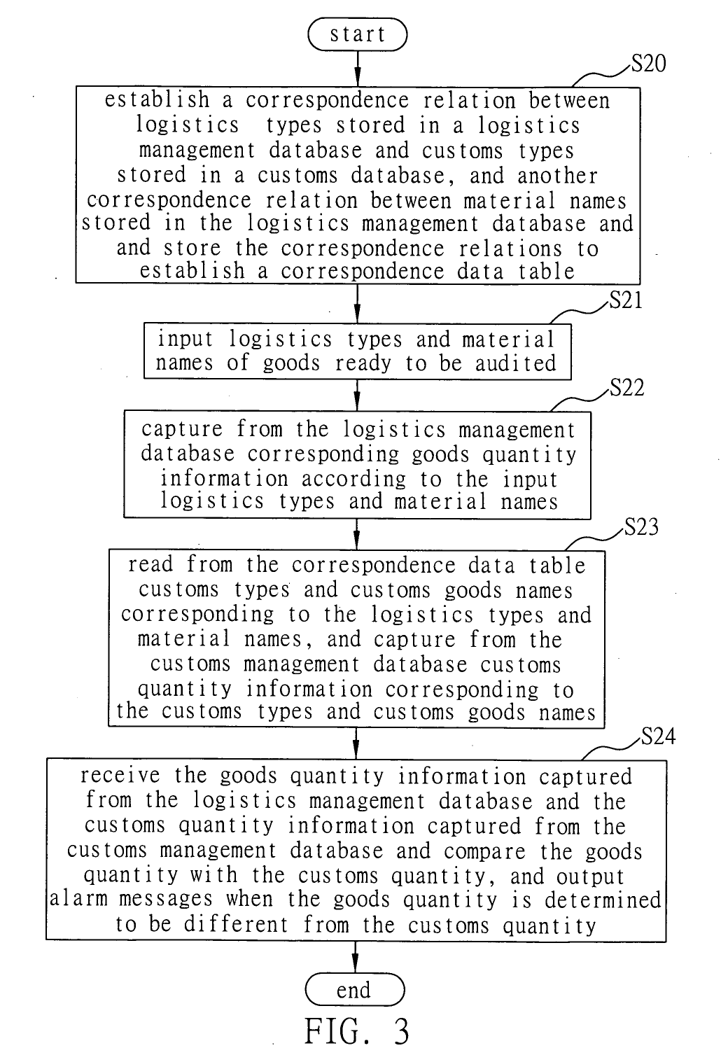

FIG. 3 is a flow chart of a logistics auditing method corresponding to the logistics auditing system 10. The method starts in step S20.

In step S20, the correspondence data table of the logistics data and the customs data is established. In other words, a correspondence relation between the logistics types of the logistics management database 110 and the customs types of the customs management database 120, and another correspondence relation between the material names of the logistics management database 110 and the customs material names of the customs management database 120 are established. Then, flow proceeds to step S21.

In step S21, the logistics types and material names of the goods, and a time cycle ready to be audited are input to the input module 101. According to the preferred embodiment, the logistics types of the goods ready to be audited are the input process, the material names of the goods ready to be audited are the material ‘A’ and the product ‘G’, and the time cycle is 05/11/01 to 05/11/15. Then flow proceeds to step S22.

In step S22, goods quantity information is captured from the logistics management database 110 in accordance with the logistics types and the material names input to the input module 101. According to the preferred embodiment, a goods quantity information with the number 10,000 for material ‘A’ and the number 1,000 for product ‘G’ has been processed by the input process during the time cycle 05/11/01 to 05/11/15. Then, flow proceeds to step S23.

In step S23, customs types and customs material names corresponding to the logistics types and material names of the goods ready to be audited are read from the correspondence data table generated by the correspondence module 100, so that the customs quantity information corresponding to the customs types and the customs material names can be captured from the customs management database 120. According to the preferred embodiment, the customs material names corresponding to the material ‘A’ and the product ‘G’ and read from the correspondence data table are the goods ‘a’ and the goods ‘g’ respectively, and the import customs quantity of the goods ‘a’ and ‘g’, for example 10,001 and 1,000 respectively, are captured during the time cycle. Then, flow proceeds to step S24.

In step S24, the goods quantity information and the customs quantity information are received and compared to each other, so as to output the alarm messages when the material quantity being compared is determined to be different from the customs quantity. According to the preferred embodiment, when the input quantity 10,000 of the material ‘A’ is compared to be different from the import customs quantity 10,001 of the goods ‘a’, the alarm messages are output, and a quantity difference between the material ‘A’ and the goods ‘a’ is displayed on a display apparatus, allowing an auditor to timely execute a source probing process.

The present invention further provides a stock early warning function, a form tracking function, and a unit price analyzing function according to the logistics data of the logistics management database 110.

The stock early warning function refers to functionality wherein the logistics auditing system 10 calculates a current theoretical stock quantity and compares the current theoretic stock quantity with a real stock quantity of the logistics data recorded in the ERP system 11 according to an input quantity, an output quantity, and an initial quantity (that is a stock quantity gathered previously), and outputs alarm messages if the theoretical stock quantity being compared is determined to be different from the real stock quantity.

The form tracking function is used for tracking if enterprise form data (including material consumption quantity and product quantity) are in accordance with depot access data (including material input quantity and product output quantity), and outputting alarm messages when the enterprise form data are tracked not to be in accordance with the depot access data. Both of the enterprise form data and the depot access data are stored in the logistics management database 110 of the ERP system 11.

The unit price analyzing function refers to functionality wherein the logistics auditing system 10 calculates a minimum unit price, an average unit price, a weighted average unit price, and a maximum unit prices according to an import/export export and compares these prices with a declared unit price written on a declaration customs form, and outputs alarm messages if the declared unit price being compared is determined to be equal to the minimum unit price. The import/export export is stored in the logistics management database 110 of the ERP system 11 and the customs management database 120 of the customs system 12.

In summary, by comparing the logistics data stored in the logistics management database of the enterprise resource planning system and the customs data stored in the customs management database of the customs system, the logistics auditing system and method of the present invention are allowed to monitor and manage the logistics process of an enterprise, and improve the logistics auditing efficiency.

Moreover, the logistics auditing system and method of the present invention can be used to audit the goods quantity information during any time cycles, so as to improve the monitoring operability of enterprise logistics. An enterprise can be informed by the alarm messages generated due to a difference between the material quantity and the customs quantity that the enterprise has to execute the source probing process. Therefore, the enterprise can urge related personnel to amend related information, and provide correct ERP data to the customs officials.

The foregoing descriptions of the detailed embodiments are illustrated to disclose the features and functions of the present invention and are not restrictive of the scope of the present invention. It should be understood by those in the art that various modifications and variations can be made to the present invention according to the spirit and principle in the disclosure and yet fall within the scope of the appended claims.

What is claimed is:

1. A logistics auditing system connected with an enterprise resource planning (ERP) system having a logistics management database and a customs system having a customs management database for monitoring and managing goods ready to be audited, the logistics management database being used to store a variety of logistics data including logistics types, material names, and goods quantity information, the customs management database being used to store a variety of customs data including customs types, customs material names, and customs quantity information, the logistics auditing system comprising:
a correspondence module for establishing a correspondence data table listing a correspondence relation between the logistics data and the customs data;
an input module for inputting the logistics types and the material names of the goods ready to be audited;
a capture module for capturing corresponding goods quantity information from the logistics management database according to the logistics types and material names input to the input module, and reading from the correspondence data table established by the correspondence module customs types and customs material names of the logistics types and material names of the goods ready to be audited, so as to capture from the customs management database the customs quantity information corresponding to the customs types and the customs material names; and
a comparison module for receiving the goods quantity information and the customs quantity information and comparing the material quantity with the customs quantity, and for generating alarm messages when the material quantity being compared is determined to be different from the customs quantity.

2. The logistics auditing system of claim 1, wherein a logistics type is a logistics type selected from the group consisting of an input process and an output process for goods.

3. The logistics auditing system of claim 1, wherein the a customs type refers to a customs type selected from the group consisting of an import customs process and an export customs process for goods.

4. The logistics auditing system of claim 1, wherein the input module is used further to input a time cycle for the goods ready to be audited.

5. A logistics auditing method applicable to an ERP system having a logistics management database and a customs system having a customs management database for monitoring and managing goods ready to be audited, the logistics management database being used to store a variety of logistics data including logistics types, material names, and goods quantity information, the customs management database being used to store a variety of customs data including customs types, customs material names, and customs quantity information, the logistics auditing method comprising:
establishing a correspondence data table listing a correspondence relation between the logistics data and customs data;
inputting logistics types and material names of the goods ready to be audited;
capturing from the logistics management database corresponding goods quantity information according to the logistics types and material names of the goods ready to be audited;
reading customs types and customs material names corresponding to the logistics types and material names of the goods ready to be audited, and capturing from the customs management database customs quantity information corresponding to the customs types and customs material names; and
receiving the goods quantity information and the customs quantity information and comparing the material quantity with the customs quantity, and outputting alarm messages when the material quantity being compared is determined to be different from the customs quantity.

6. The logistics auditing method of claim 5, wherein a logistics type refers to a logistics type selected from the group consisting of an input process and an output process for goods.

7. The logistics auditing method of claim 5, wherein a customs type refers to a customs type selected from the group consisting of an import customs process and an export customs process for goods.

8. The logistics auditing method of claim 5, wherein inputting logistics types and material names of the goods ready to be audited is implemented by an input module, and the input module is further used to input a time cycle of the goods ready to be audited.
